(19) United States
(12) Patent Application Publication
(10) Pub. No.: US 2010/0320158 A1
(43) Pub. Date: Dec. 23, 2010

(54) SEPARATOR SEPARATING CHIPS AND OTHER MATERIAL FROM COOLANT AND METHOD

(76) Inventors: Brian Mahas, Maumee, OH (US); Barry Benschoter, Bowling Green, OH (US); Marc Gelinas, Tiffin, OH (US); Charles Hughes, Findlay, OH (US)

Correspondence Address: HOWARD & HOWARD ATTORNEYS PLLC, 450 West Fourth Street, Royal Oak, MI, 48067, US

(21) Appl. No.: 12/795,012

(22) Filed: Jun. 7, 2010

Related U.S. Application Data
(60) Provisional application No. 61/218,629, filed on Jun. 19, 2009.

(51) Int. Cl. F01M 11/03; B01D 35/02

(52) U.S. Cl. 210/776; 210/167.04

(57) ABSTRACT

A separator for separating chips in a coolant generated by a workstation from other objects, including a conveyor having an inclined portion removing chips and other objects from the coolant, a separator plate beneath the conveyor including an inclined portion extending parallel to the conveyor having a plurality of generally parallel slots receiving the chips therethrough and enlarged openings adapted to receive the other objects therethrough, and a pump transferring the chips and coolant to a filter.

### RELATED APPLICATION

This application claims priority to U.S. Provisional Patent Application Ser. No. 61/218,629 filed Jun. 19, 2009.

### FIELD OF THE INVENTION

This invention relates to a separator for separating chips in a coolant generated by a machining work station from other material and a method of separation.

### BACKGROUND OF THE INVENTION

Modern machining operations typically use a coolant and lubricant, such as cutting oil, and generate chips which are collected in the coolant. The coolant is recycled and re-used in further machining operations and the chips may be a valuable resource which may be collected and recycled. Some machining operations include a lathe tool that that generates circular chip sections by rotating the workpiece, so that the cutting tool can peel off material, creating a smooth round surface. A drill punch is used to remove metal and form a hole or opening. Other tools and machining operations are used for various types of metal removal such as, for example, milling machines, saws and grinding tools.

Such machining operations, where chips are removed from the workpiece, liquid coolant is required to cool the workpiece and the machining tool and to lubricate the machining tool and to take away chips removed from the workpiece during the machining. A filtration system removes the chips from the workstation, filtering the chips from the coolant and the coolant is recycled to the work station. In a typical application, various objects, such as tools, drill bits, gloves and the like are dropped in the coolant and are trapped in the conveyance device. Such foreign objects may cause damage to the pump impellers, thereby terminating the entire machining operation until the pumps are cleaned or replaced based upon the degree of damage or service to bring the pumps to normal operating condition. The replacement or service of the pumps may take a substantial period of time and expense, resulting in large operational losses.

There has been a longfelt need for a separator which separates various objects from liquid coolant and chips in machining operations. As used herein, the term “coolant” includes any liquid used in a machining operation, including but not limited to cutting oils, etc. and “other objects” includes any object, such as tools, drill bits, gloves and the like which may be contained in the coolant during machining operations.

### SUMMARY OF THE INVENTION

The separator of this invention may be integrated into a work station to separate chips in a coolant generated by the work station from other objects, such as tools, screwdrivers, drill bits, gloves and the like that may be disposed in the coolant. The separator includes a conveyor beneath the work station including an inclined portion removing and conveying the chips and other objects from the coolant received from the work station. The separator further includes a separator plate beneath the conveyor including an inclined portion may extend generally parallel to the inclined portion of the conveyor having a plurality of generally parallel slots having a dimension to receive the chips therethrough which fall back into the coolant. The slots in the separator plate include an enlarged opening adjacent an upper portion of the slots separating the other objects from the cutting oil and the chips. The separator further includes a pump transferring chips and coolant to a filter for removing the chips from the coolant. The separator of this invention thus separates the coolant, chips and other objects in a simple apparatus improving efficiency, reducing downtime and costs.

In the disclosed embodiment, the separator plate includes an arcuate portion in cross-section followed by the inclined portion extending generally parallel to the conveyor. The slots in the separator plate may be inclined relative to the direction of travel of the conveyor or parallel to the direction of travel. In the disclosed embodiment, the slots in the separator plate are keyhole-shaped, including a generally circular hole at the end of the slots. The circular opening of the keyhole-shaped slots have a dimension sufficient to permit the handle of a screwdriver, for example or the head of a bolt, etc. to be received therethrough and the separator includes a basket opposite the enlarged openings in the slots receiving the other objects from the separator plate. In the disclosed embodiment, the basket is formed of a screen or mesh allowing the liquid coolant to fall back into the tank. The conveyor of the disclosed embodiment includes a plurality of flights interconnected by chains pushing the chips and other objects up the inclined portion of the separator plate over the slots.

As will be understood by a person of ordinary skill in this art from the description of an embodiments of the separator of this invention, the method of separating chips and other material from coolant includes conveying the chips and other objects up an incline separator plate above the level of the coolant, separating the chips and other materials from the coolant. The method then includes separating the chips from the other material by providing slots in the separator plate having a width permitting the chips to be received through the slots. The chips then fall back into the coolant, but are separated from the other material. The method of this invention then includes collecting the other material from the separator plate by providing enlarged openings in the slots having a dimension sufficient to allow the other material to be received therethrough into a collection container, such as a basket. Some larger objects may be conveyed over the top of the separation plate into the basket. The method of this invention may further include pumping the chips and coolant to a filter, removing the chips from the coolant. The other material may then be periodically collected from the container.

As will be understood by those skilled in this art, various modifications may be made to the disclosed embodiments of the separator and method of this invention within the purview of the appended claims. The disclosed embodiments of the separator and method of this invention are for illustrative purposes only and do not limit this invention except as set forth in the claims.

### BRIEF DESCRIPTION OF THE DRAWINGS

FIG. 1 is sideview, partially schematic, of one embodiment of the separator of this invention;

FIG. 2 is a sideview of the portion of FIG. 1 shown by the box;

FIG. 3 is an enlarged partially cross-sectioned sideview of a portion of the separator shown in FIG. 1;

FIG. 4 is a top partially cross-sectioned view of FIG. 3 in the direction of view arrows 4-4;

FIG. 5 is a sideview of a portion of FIG. 2 in the direction of view arrows 5-5;

FIG. 6 is a top view of one embodiment of the separator plate;

FIG. 7 is an enlarged view of the upper end of the separator plate as shown in FIG. 5;

FIG. 8 is a sideview of the lower end of the separator plate as shown in FIG. 6; and

FIG. 9 is a top view of an alternative embodiment of the separator plate shown in FIG. 6.

### DESCRIPTION OF THE PREFERRED EMBODIMENTS

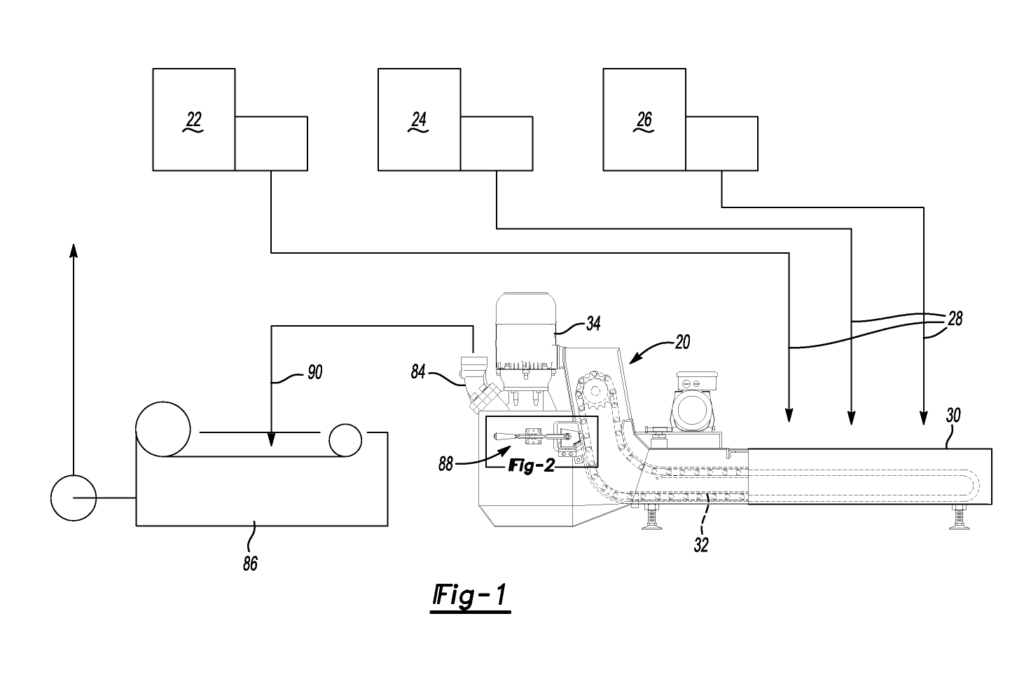

As set forth above, the separator 20 may be used to separate chips in a coolant generated by the workstation from other objects, such as tools, work gloves or the like. As shown in FIG. 1, the separator 20 may be integrated into workstations 22, 24 and 26 including cutting machines (not shown), wherein chips are generated from the workpiece and coolant, such as cutting oil, is used to cool the cutting tool and the workpiece and the chips generated by the workstations with the cutting oil is then delivered to the separator 20 as shown by arrows 28. As will be understood by those skilled in this art, the workstations may be located above an end of the housing 30 and openings may be provided through the housing, wherein the workstations 22, 24 and 26 discharge chips and coolant directly through the opening onto the conveyor 32 described below. As also set forth above, other objects, including tools, drill bits, gloves and the like are often disposed into the coolant which should be removed prior to pumping the chips and coolant to a filter to remove the chips to avoid damage to the pump as described below.

Referring now specifically to FIG. 3, the disclosed embodiment of the separator 20 includes a chain link conveyor 32 having a plurality of flights 36 interconnected by chain links 38 entrained on drive sprocket 40 driven by a motor (not shown), driving the flights 36 and links as shown by arrow 42, such that the flights overlying the separator plate 46 (described below) as shown by arrow 44.

The separator plate includes a plurality of generally parallel elongated slots dimensioned to allow the chips to fall through the slots back into the liquid coolant 48 shown in FIG. 3. The other objects are conveyed upwardly, to enlarged openings, in the separator plate 46 as now described.

FIG. 6 illustrates one embodiment of a separator plate 50 having generally parallel elongated slots 52. In this embodiment, the lower portion 54 of the slots are angled relative to the axis of the conveyor 32 as shown in FIG. 6. The upper portions 56 extend parallel to the axis of the conveyor 32. In this embodiment, the slots 52 are keyhole-shaped, each having an enlarged opening 58 adjacent the top edge of the top 60 of the separator plate 50 as shown in FIG. 6. The enlarged openings 58 are large enough to permit other larger objects to fall therethrough as shown by arrow 62 into the basket 64 as shown in FIG. 3. Other larger objects will be dragged over the top end 60 of the separator plate as shown by arrow 66 into the basket 64. In this embodiment, the upper edge 60 of the separator plate 50 includes a champhor 68 which facilitates or guides the other articles into the basket 64 as shown in FIG. 7.

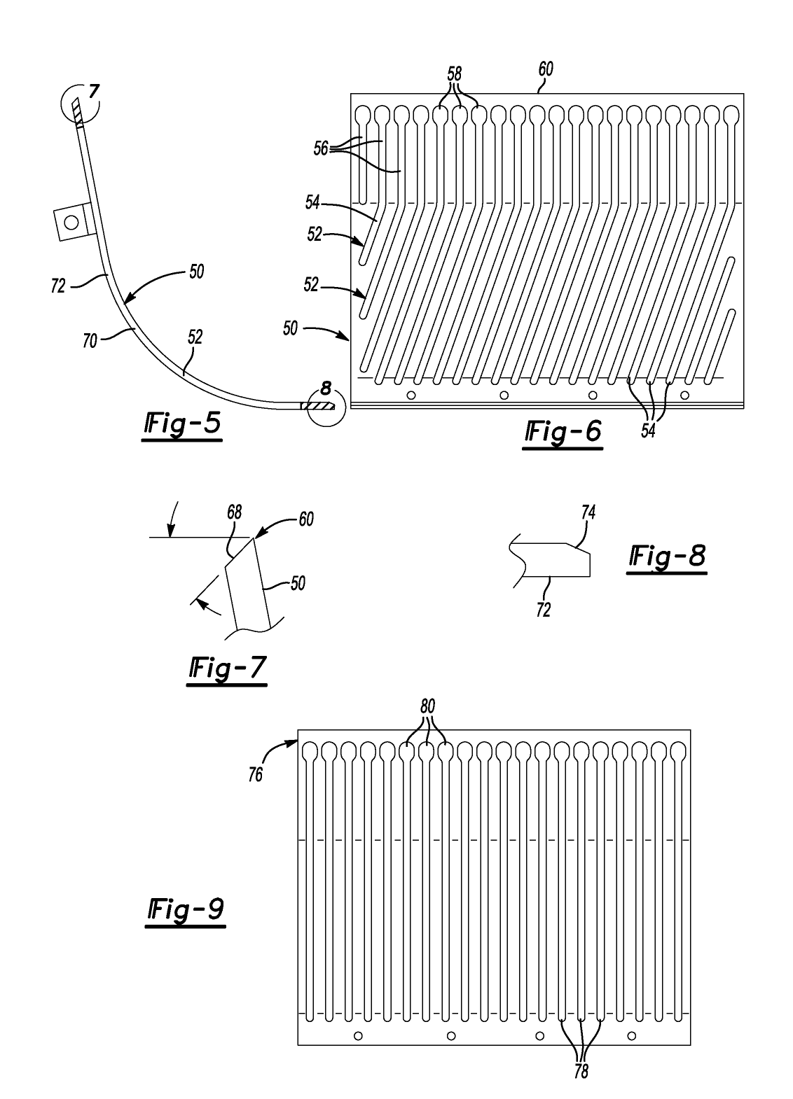

In one preferred embodiment, the separator plate 50 includes an arcuate intermediate portion 70 (in cross section) which smoothly blends into the inclined portion 72 as shown in FIG. 5 which facilitates movement of the chips and other objects up the inclined portion to the slots 52. In the disclosed embodiment, the lower end 72 of the separator plate 50 includes a champhor 74 which facilitates movement of the chips and other objects onto the separator plate 50 as shown in FIG. 8. The embodiment of the separator plate 76 shown in FIG. 9 includes a plurality of parallel elongated slots 78 all of which extend parallel to the axis of the conveyor 32. Each of the slots includes an enlarged opening 80 adjacent the upper end of the slots, such that the slots are keyhole-shaped as shown in FIG. 9. Otherwise, the separator plate 76 shown in FIG. 9 may be identical to the separator plate 50 shown in FIG. 6. However, various modifications may be made to the separator plate within the purview of the appended claims. For example only, the elongated slots may extend at a sharper angle relative to the axis of the conveyor 32 or the elongated slots may be wedge-shaped such that the enlarged opening is not separate and distinct from the slots, and the enlarged openings may be spaced from the top of the slots.

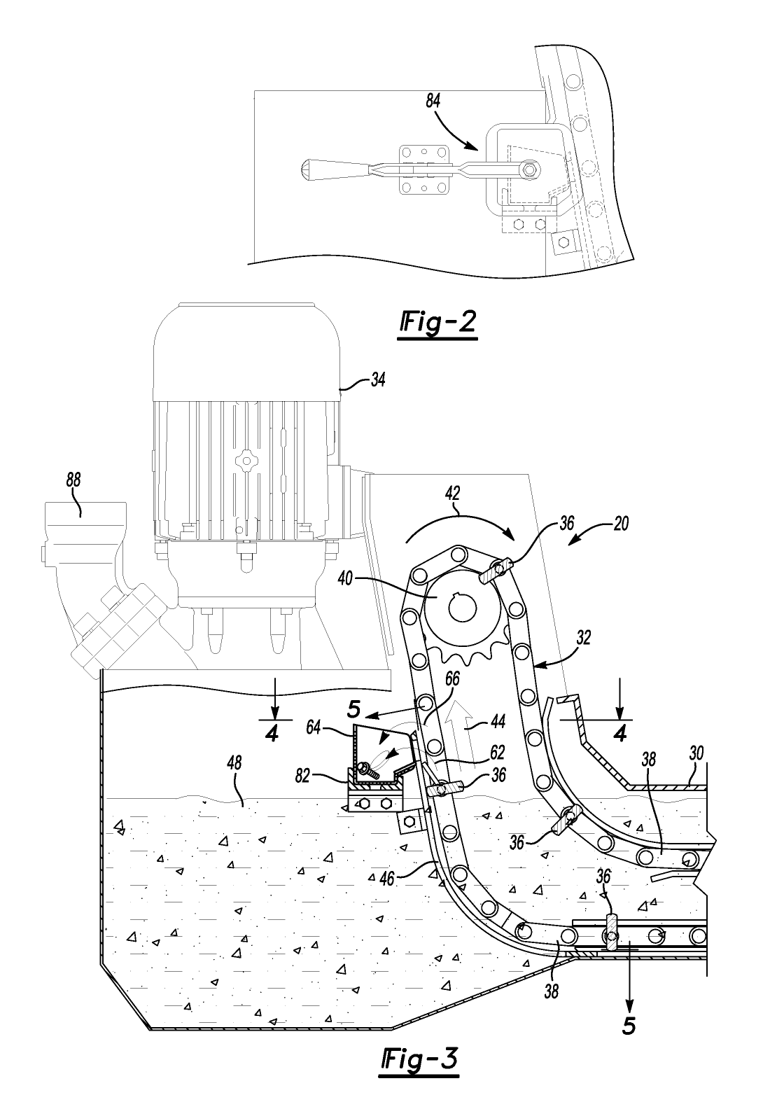

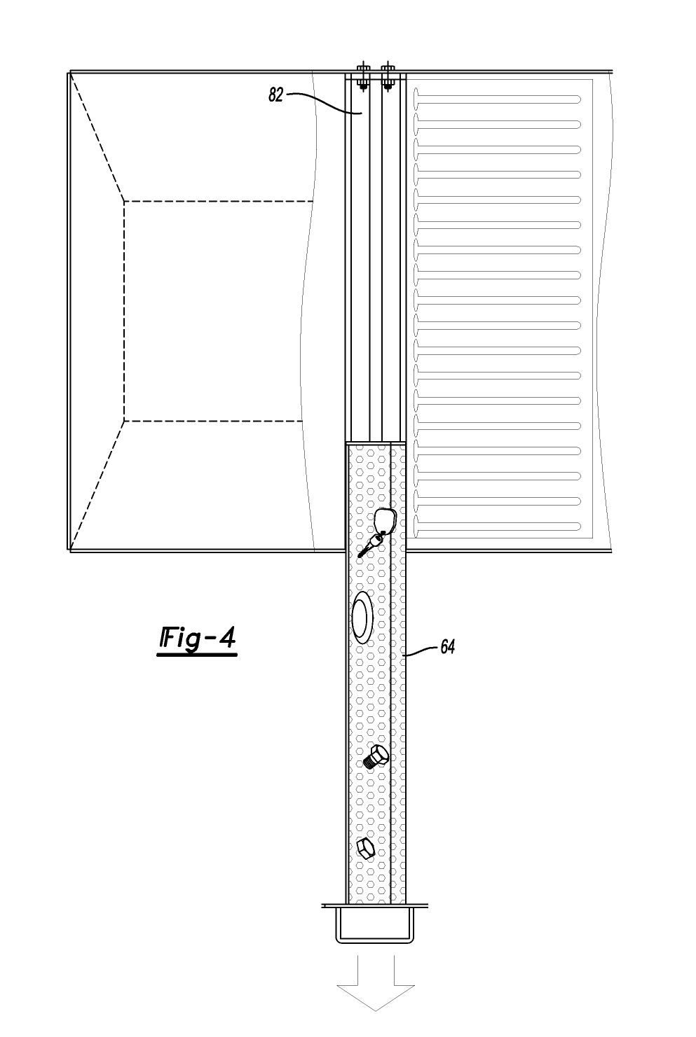

As will be understood from the above description of the preferred embodiments of the separator of this invention, the method of separating chips and other objects from coolant includes conveying the chips and other objects up an inclined portion of a separator plate above the level of the coolant, separating the chips and other objects from the coolant, then separating the chips and other objects by providing slots in the separator plate having a width permitting the chips to be received through the slots and finally collecting the other objects from the separator by providing enlarged openings in the slot or the other objects may be dragged over the top of the separator plate. In the disclosed embodiment, the basket 64 which received the other objects is porous or formed of a mesh, such that the liquid coolant falls through the basket into the liquid coolant 48 below the basket. Further, the basket 6 in the disclosed embodiment is slideably supported on a U-shaped frame 82 as shown in FIGS. 3 and 4. The basket may be locked in place by a toggle clamp 84 shown in FIGS. 1 and 2 to assure that the basket stays in place during use. In a typical application, the basket recovers various objects from the coolant, including keys, bolts, nuts, paper, gloves, et cetera in FIG. 1.

Finally, the chips and coolant are separated in a filter 86, the chips and coolant are pumped by pump 34 through pipe 88 into the filter 86 as shown by arrow 90.

As will be understood by those skilled in this art, various modifications may be made to the separator and method of this invention within the purview of the appended claims. The inclined portion 72 of the separator plate 46, 52 is preferably inclined at an angle of greater than 60 degrees, more preferably greater than 70 degrees, but less than 90 degrees. Other types of conveyors may also be used.

1. A separator for integration into a work station separating chips in a coolant generated by the work station from other objects, comprising:
a conveyor, including an inclined portion removing and conveying chips and other objects from the coolant received from the work station;
a separator plate beneath the conveyor, including an inclined portion extending parallel to the conveyor receiving chips and other objects on the conveyor having a plurality of generally parallel slots receiving the chips therethrough extending generally in the direction of travel of the conveyor, the slots including an enlarged opening adjacent an upper portion of the slots receiving the other objects therethrough and separating the other objects from the chips; and
a pump transferring chips and coolant to a filter for removing the chips from the coolant.

2. The separator as defined in claim 1, wherein the separator plate includes an arcuate portion in cross-section followed the inclined portion extending parallel to the conveyor.

3. The separator as defined in claim 1, wherein the slots in the separator plate are inclined relative to the direction of travel of the conveyor.

4. The separator as defined in claim 1, wherein the slots in the separator plate are keyhole-shaped, including a generally circular hole at the upper end of the slots.

5. The separator as defined in claim 1, wherein the conveyor includes a plurality of flights interconnected by chains pushing the chips and other objects up the inclined portion of the separator plate over the slots.

6. A method of separating chips and other objects from coolant, comprising the following steps:
conveying the chips and other objects up an inclined separator plate above the coolant, separating the chips and other material from the coolant;
separating the chips from the other objects by providing slots in the separator plate having a width permitting the chips to be received through the slots;
collecting the other objects from the separator plate by providing enlarged openings in the slots permitting the other material to be received through the openings; and
collecting the other material in a basket located below the enlarged openings in the separator plate.

7. The method as defined in claim 6, wherein the method further includes pumping the chips and coolant into a filter, removing the chips from the coolants.
